(19) United States
(12) Patent Application Publication
(10) Pub. No.: US 2015/0258840 A1
(43) Pub. Date: Sep. 17, 2015

(54) POSITIONING STRUCTURE FOR A CLIPBOARD

(71) Applicant: Chun Yuan Chang, Taipei (TW)

(72) Inventor: Chun Yuan Chang, Taipei (TW)

(21) Appl. No.: 14/207,673

(22) Filed: Mar. 13, 2014

(51) Int. Cl. B42F 9/00; B65D 25/10

(52) U.S. Cl. CPC B42F 9/001; B65D 25/10

(57) ABSTRACT

A positioning structure for a clipboard contains a first cover, a second cover, and two connecting grooves. The first cover includes a first retaining slot, a second retaining slot and a plurality of second recesses. The second cover includes a third retaining slot, a fourth retaining slot and a plurality of second recesses. At least one clamper is used to clamp at least one paper, and each of the at least one clamper includes a press block, an actuating segment, an inserting piece extending downwardly from a rear end of the press block, a side plate connected with two sides of the inserting piece, a recessed portion defined on the inserting piece, a reinforcement sheet extending outwardly from a front end of the inserting piece, and a locking piece extending downwardly from a bottom end of the reinforcement sheet in front of the inserting piece.

### BACKGROUND OF THE INVENTION

1. Field of the Invention

This application is a Continuation-in-Part of application Ser. No. 13/109,014, filed on 17 May 2011.

2. Description of the Prior Art

A conventional clipboard includes a first cover and a second cover which are closed together, and at least one retainer for retaining the first cover and the second cover together, the first cover and the second cover are made by two molds, thus increasing production cost.

Moreover, when a single paper or a single catalog is placed in the clipboard, the single paper or the single catalog cannot be clamped in the clipboard securely.

The present invention has arisen to mitigate and/or obviate the afore-described disadvantages.

### SUMMARY OF THE INVENTION

The primary objective of the present invention is to provide a positioning structure for a clipboard in which each of at least one clamper is movably inserted or removed from any one of a plurality of first recesses and a plurality of second recesses based on using requirement.

Another objective of the present invention is to provide a positioning structure for a clipboard which retains the at least one clamper in each first recess by ways of an inserting piece and a locking piece securely.

To obtain the above objectives, a positioning structure for a clipboard provided by the present invention contains:

a first cover and a second cover which are made by a mold and correspond to each other, two connecting grooves defined on a connection portion of the first cover and the second cover and retaining with two retainers;

the first cover including a first retaining slot and a second retaining slot which are formed on one of four peripheral sides of the first cover, and the second cover including a third retaining slot and a fourth retaining slot which are arranged on a peripheral side of the second cover and correspond to the first retaining slot and the second retaining slot;

wherein the first cover also includes a plurality of first recesses arranged on another three of the four peripheral sides thereof, the second cover also includes a plurality of second recesses arranged on another three of the four peripheral sides thereof;

wherein at least one clamper is used to clamp at least one paper, and each of the at least one clamper includes a press block one piece formed, an actuating segment disposed on a front end of the press block, an inserting piece extending downwardly from a rear end of the press block, a side plate connected with two sides of the inserting piece, a recessed portion defined on the inserting piece, a reinforcement sheet extending outwardly from a front end of the inserting piece, and a locking piece extending downwardly from a bottom end of the reinforcement sheet in front of the inserting piece.

### BRIEF DESCRIPTION OF THE DRAWINGS

FIG. 1 is a perspective view showing the assembly of a positioning structure for a clipboard according to a first embodiment of the present invention.

FIG. 2 is a plan view showing the assembly of the positioning structure for the clipboard according to the first embodiment of the present invention.

FIG. 3 is a perspective view showing the application of a clamper of the positioning structure for the clipboard according to the first embodiment of the present invention.

FIG. 4 is a perspective view showing the exploded components of the positioning structure for the clipboard according to the first embodiment of the present invention.

FIG. 5 is a perspective view showing the assembly of the clamper of the positioning structure for the clipboard according to the first embodiment of the present invention.

FIG. 6 is a cross sectional view showing the application of the clamper of the positioning structure for the clipboard according to the first embodiment of the present invention.

FIG. 7 is a perspective view showing the application of the positioning member of the positioning structure for the clipboard according to the first embodiment of the present invention.

FIG. 8 is a perspective view showing the assembly of a positioning member of a positioning structure for a clipboard according to a second embodiment of the present invention.

FIG. 9 is a perspective view showing the application of a clamper of the positioning member of the positioning structure for the clipboard according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

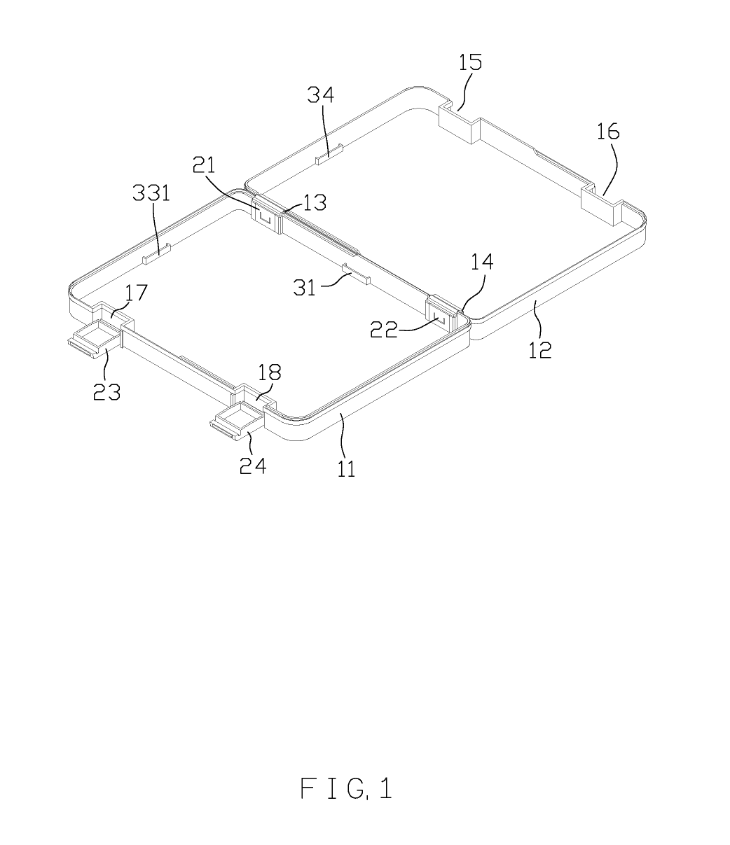

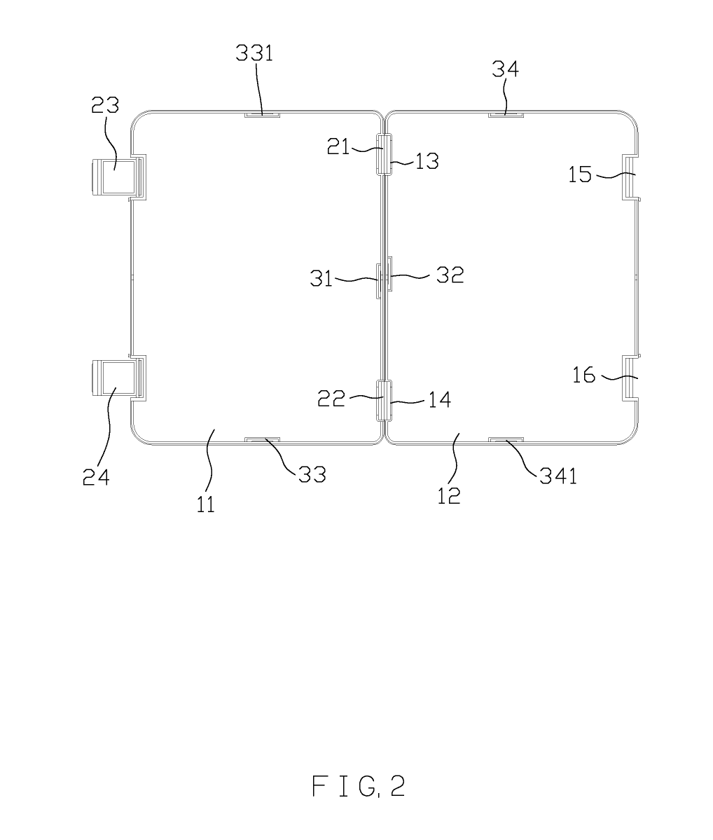

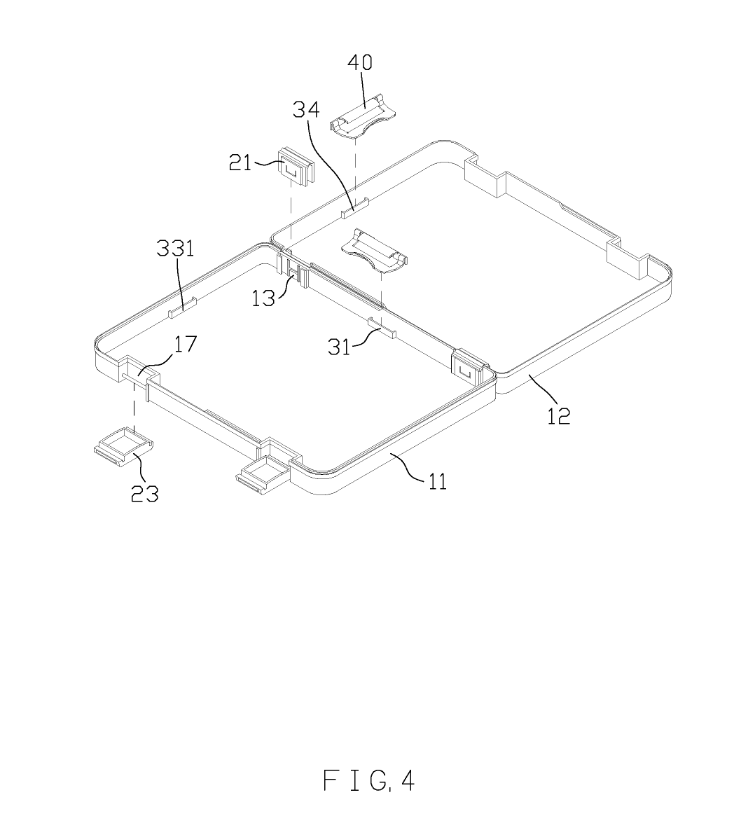

With reference to FIGS. 1-4, a positioning structure for a clipboard in accordance with a first embodiment of the present invention comprises: a first cover 11 and a second cover 12 which are made by a mold and correspond to each other, two connecting grooves 13, 14 defined on a connection portion of the first cover 11 and the second cover 12 and retaining with two retainers 21, 22, such that the first cover 11 and the second cover 12 are opened and closed; the first cover 11 includes a first retaining slot 17 and a second retaining slot 18 which are formed on one of four peripheral sides of the first cover 11, and the second cover 12 includes a third retaining slot 15 and a fourth retaining slot 16 which are arranged on a peripheral side of the second cover 12 and correspond to the first retaining slot 17 and the second retaining slot 18, such that a first retainer 23 is fixed in the first retaining slot 17 and is retained with the third retainer 15, and a second retainer 24 is mounted in the second retaining slot 18 and is engaged with the fourth retainer 16. Furthermore, the first cover 11 also includes a plurality of first recesses 31, 33, 331 arranged on another three of the four peripheral sides thereof; the second cover 12 also includes a plurality of second recesses 32, 34, 341 arranged on another three of the four peripheral sides thereof.

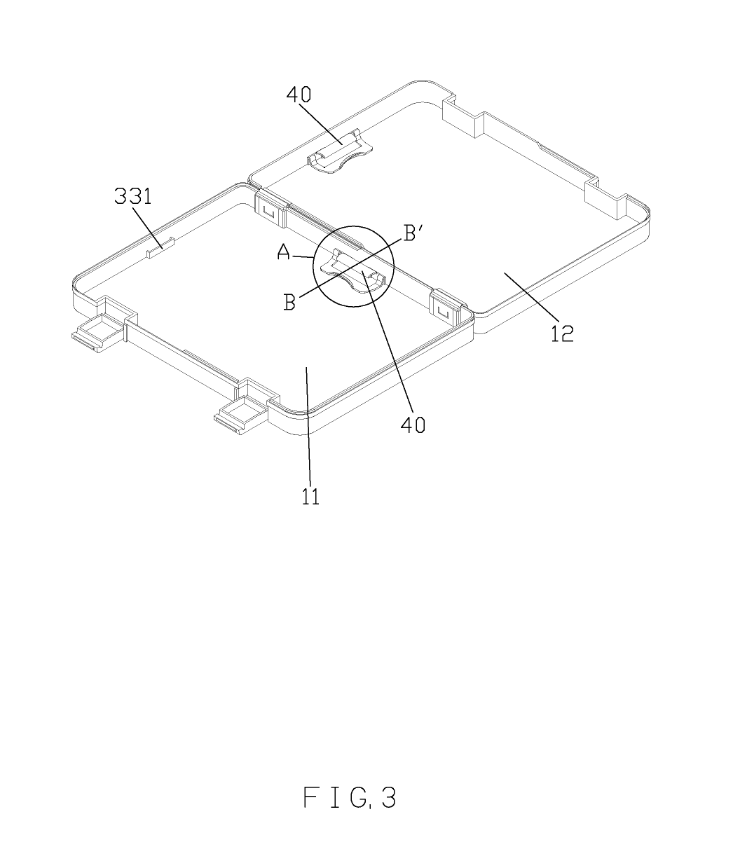

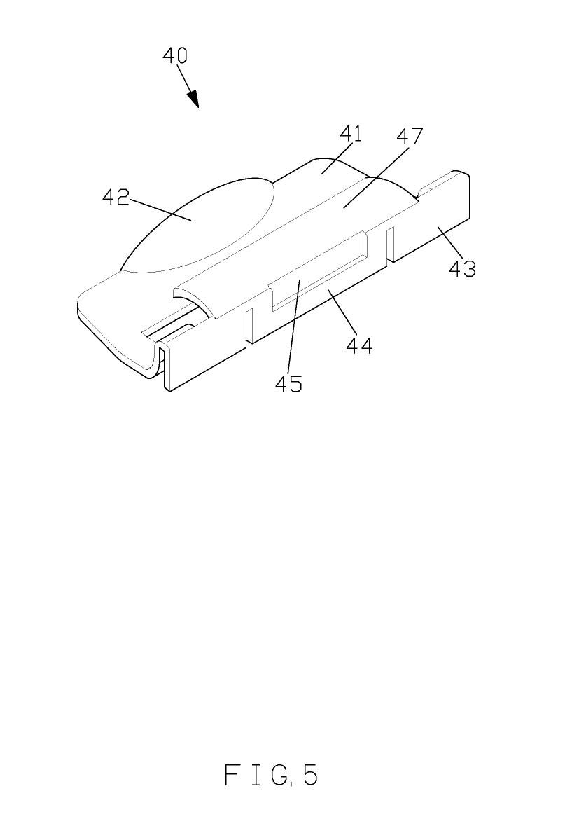

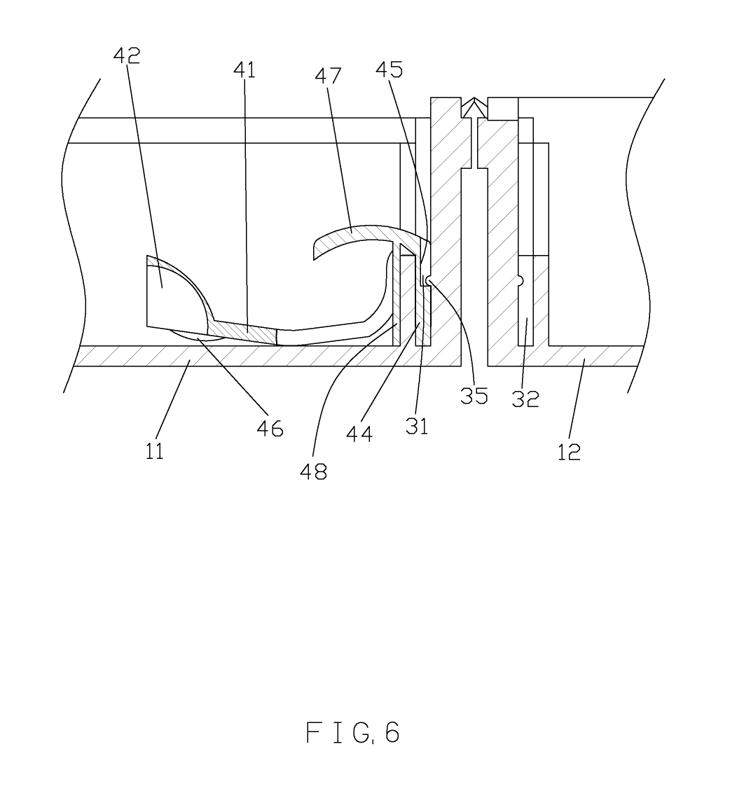

Referring to FIGS. 3-6, the plurality of first recesses 31, 33, 331 and the plurality of second recess 32, 34, 341 are one piece formed and are employed to insert at least one clamper 40 for clamping at least one paper, wherein each of the at least one clamper 40 includes a press block 41 one piece formed, an actuating segment 42 disposed on a front end of the press block 41, an inserting piece 44 extending downwardly from a rear end of the press block 41, a side plate 43 connected with two sides of the inserting piece 44, a recessed portion 45 defined on the inserting piece 44, a reinforcement sheet 47 extending outwardly from a front end of the inserting piece 44, and a locking piece 48 extending downwardly from a bottom end of the reinforcement sheet 47 in front of the inserting piece 44. In assembly, each of the at least one clamper 40 is inserted into any one of the plurality of first recesses 31, 33, 331 and the plurality of second recess 32, 34, 341, and the inserting piece 44 is inserted into one of the plurality of first recesses 31, 33, 331 (such as a first recess 31), an abutting rib 35 in the first recess 31 retains with the recessed portion 45 of the inserting piece 44, the locking piece 48 is biased against a front end of the first recess 31, thus retaining the at least one clamper 40 in the first recess 13 by ways of the inserting piece 44 and the locking piece 48 securely. Preferably, a protrusion 46 is arranged on a bottom end of each clamper 40 so as to press the at least one paper downwardly, and the actuating segment 42 is applied to pull the press block 41 upwardly, thus releasing the at least one clamper 40.

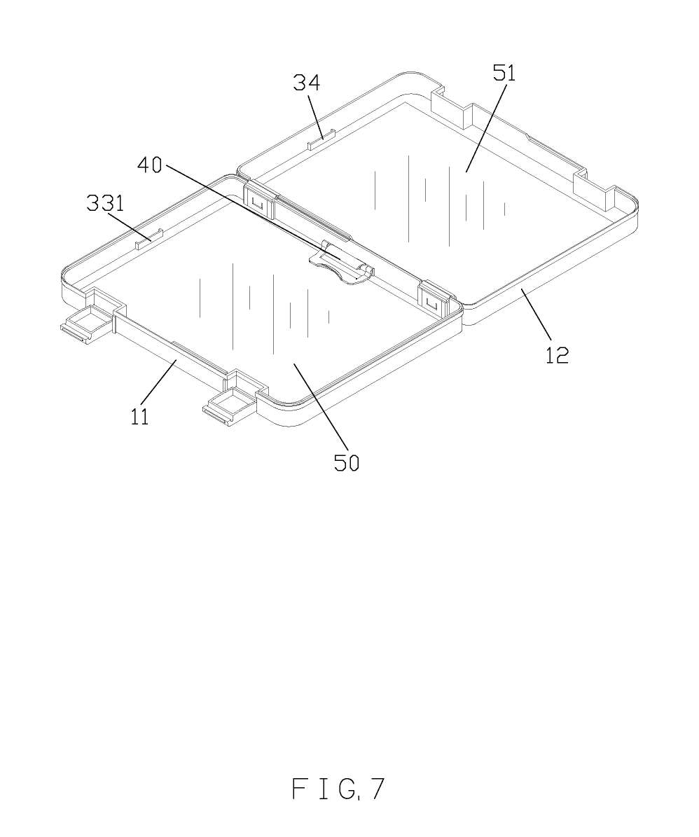

Each of the at least one clamper 40 is removed from any one of the plurality of first recesses 31, 33, 331 and the plurality of second recess 32, 34, 341. In operation, as shown in FIG. 7, a respective one of the at least one clamper 40 is inserted into the first recess 31 of the first cover 11 (i.e., the at least one clamper 40 is not inserted into the second cover 12), such that at least one first paper 50 is placed in the first cover 11 and is pressed by the at least one clamper 40, and at least one second paper 51 is placed in the second cover 12 without being pressed. Thereby, the at least one clamper 40 is inserted into any one of the plurality of first recesses 31, 33, 331 and the plurality of second recess 32, 34, 341. Preferably, a number of the at least one clamper 40 is increased based on using requirement.

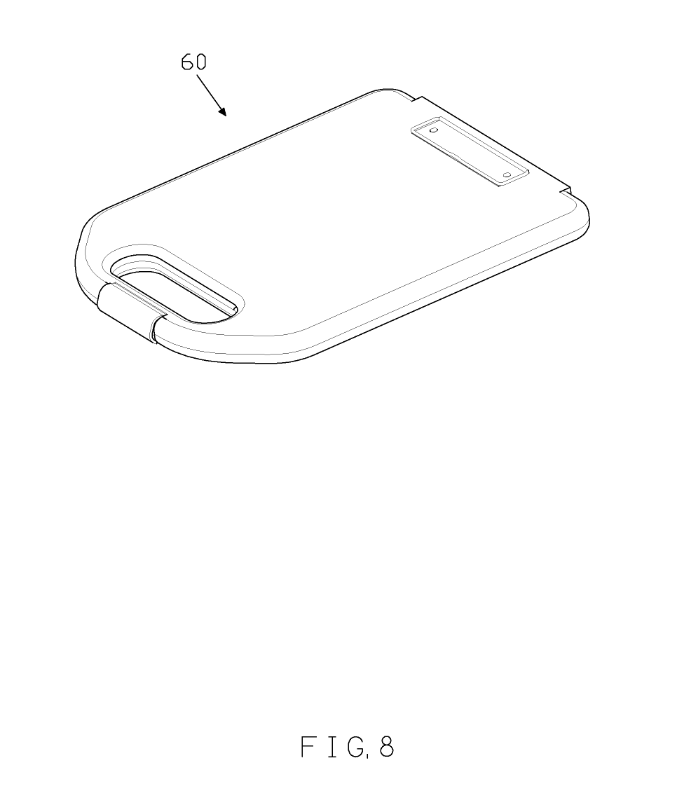

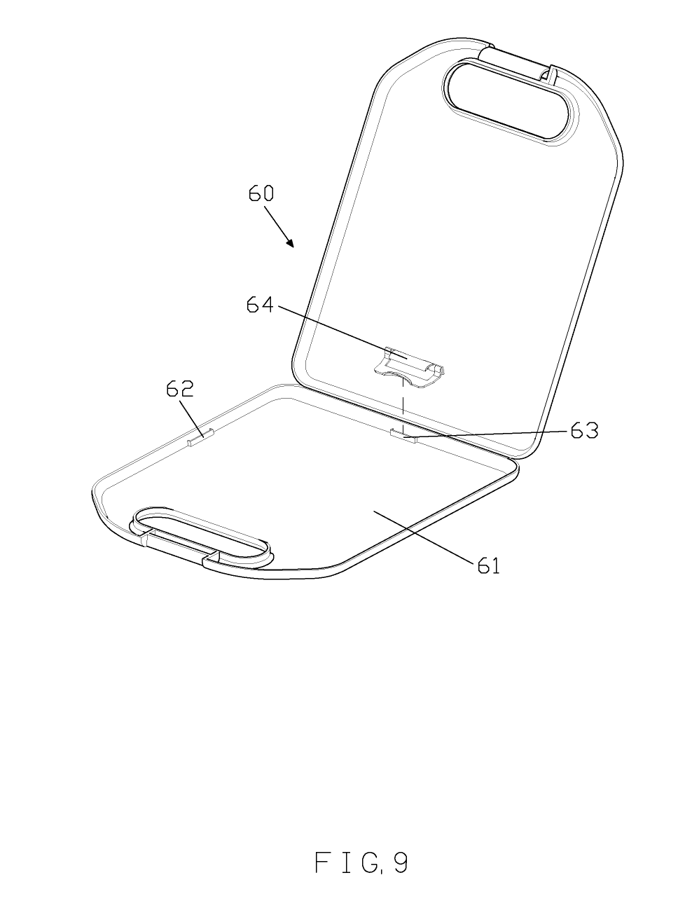

As illustrated in FIGS. 8 and 9, a positioning structure for a clipboard in accordance with a second embodiment of the present invention comprises: a covering assembly 60 for replacing the first cover and the second cover of the first embodiment, and the covering assembly 60 includes two accommodating chambers 61, wherein one of the two accommodating chambers 61 has a plurality of recesses 62, 63 defined on two of four peripheral sides thereof so as to insert at least one clamper 40.

While we have shown and described various embodiments in accordance with the present invention, it is clear to those skilled in the art that further embodiments may be made without departing from the scope of the present invention.

What is claimed is:

1. A positioning structure for a clipboard comprising:
a first cover and a second cover which are made by a mold and correspond to each other, two connecting grooves defined on a connection portion of the first cover and the second cover and retaining with two retainers;
the first cover including a first retaining slot and a second retaining slot which are formed on one of four peripheral sides of the first cover, and the second cover including a third retaining slot and a fourth retaining slot which are arranged on a peripheral side of the second cover and correspond to the first retaining slot and the second retaining slot;
wherein the first cover also includes a plurality of first recesses arranged on another three of the four peripheral sides thereof, the second cover also includes a plurality of second recesses arranged on another three of the four peripheral sides thereof;
wherein at least one clamper is used to clamp at least one paper, and each of the at least one clamper includes a press block one piece formed, an actuating segment disposed on a front end of the press block, an inserting piece extending downwardly from a rear end of the press block, a side plate connected with two sides of the inserting piece, a recessed portion defined on the inserting piece, a reinforcement sheet extending outwardly from a front end of the inserting piece, and a locking piece extending downwardly from a bottom end of the reinforcement sheet in front of the inserting piece.

2. The positioning structure for the clipboard as claimed in claim 1, wherein each of the at least one clamper is movably inserted or removed from any one of the plurality of the first recesses and the plurality of second recesses.

3. The positioning structure for the clipboard as claimed in claim 1, wherein after the inserting piece is inserted into any one of the plurality of first recesses and the plurality of second recesses, an abutting rib in the first recess retains with the recessed portion of the inserting piece, and the locking piece is biased against a front end of the first recess, thus retaining the at least one clamper in the first recess by ways of the inserting piece and the locking piece.

4. The positioning structure for the clipboard as claimed in claim 1, wherein a number of the at least one clamper is increased based on using requirement.

5. The positioning structure for the clipboard as claimed in claim 1, wherein the plurality of first recesses, the plurality of second recesses, and the at least one clamper are arranged on a covering assembly for replacing the first cover and the second cover.
